(19) United States
(12) Patent Application Publication
(10) Pub. No.: US 2009/0327722 A1
(43) Pub. Date: Dec. 31, 2009

(54) Transient Protection Key Derivation in a Computing Device

(75) Inventor: Andrew Harker, Herts (GB)

Correspondence Address: Saul Ewing LLP (Philadelphia), Attn: Patent Docket Clerk, 2 North Second St., Harrisburg, PA, 17101, US

(73) Assignee: Symbian Software Limited, LONDON (GB)

(21) Appl. No.: 12/303,282

(22) PCT Filed: Jun. 7, 2007
(86) PCT No.: PCT/GB2007/002104

§ 371 Date: Jun. 25, 2009

(30) Foreign Application Priority Data
Jun. 8, 2006 (GB) 0611351.8

(51) Int. Cl. H04L 9/32; G06F 21/20

(52) U.S. Cl. 713/168; 713/182

(57) ABSTRACT

A computing device is arranged to use any possible permutation of methods available to it to authenticate a user, without needing to persistently store any unencrypted data that can be used in authentication, such data only ever being held in transient memory. A user of the device is provided with their own unique common protection key (CPK) which can be used to guard or encrypt sensitive data and functionality. Each authentication method is guaranteed to return a unique consistent identification sequence (CIS) each time it is employed by any specific user. When a user registers on the device, the CIS from each authentication method is used to generate a key which in turn is used to encrypt the CPK; this E(CPK) is then stored in a table indexed by user and authentication method. Neither the CPK nor any CIS are ever kept on the device except in transient memory. When authentication is sought, the CIS for each requested method is obtained and is used to regenerate the key that can be used to decrypt the E(CPK). All the CPKs thus decrypted must match for authentication to be granted.

This invention relates to an improved method for operating a computing device, and in particular to an improved method for providing user authentication on a computing device.

In the context of the present invention, authentication refers to the process by which the identity claimed by an individual is verified. It is frequently used in conjunction with computing devices to enable a user of the device to gain access to specific data and services which are only authorised for use by a particular individual. Such devices include, without being limited to, desktop and laptop computers, Personal Digital Assistants (PDAs), mobile telephones, smartphones, set-top boxes and games consoles, together with converged devices incorporating the functionality of one or more of the classes of device referred to above, as well as many other industrial and domestic electronic appliances such as ATM machines, digital cameras and digital music players.

Simple password protection is perhaps the most common means of authentication on such devices; an individual confirms their identity by typing in a password, which is then passed through a one-way hash with the result being compared to a previous version of the hashed password stored on the device. If there is a match, access is permitted; if there is a discrepancy, access is refused.

However, it is known that this authentication mechanism is not sufficient to protect any sensitive information that may be stored on the device. This may include commercially or personally valuable data, such as banking access keys and private addresses. The reason for this is that protecting access to the device by means of a password while leaving the data store as plain text data does not adequately protect the information if unauthenticated access to the raw file storage is possible without having to enter the password.

One example of such an attack is via software such as viruses or spyware which can infect the device, gain access to information, and either destroy it or steal it. Another example is where someone with physical access to the device accesses the storage hardware on the device directly; the simplest way of doing this would be to physically remove the memory storage from one device and then insert it in a different device.

To protect against such attacks, owners of computing devices commonly employ encryption technology to further protect their most sensitive data, with full access only being possible on provision of a specific decryption key. This is far more secure than simply password protecting use of a device, because even if the data is compromised by bypassing normal access methods, the fact that it is encrypted renders it unintelligible to anyone who does not possess the keys that provide the means of decrypting it.

It is logically impossible for those keys themselves to be stored in encrypted form; but at the same time, storing them on the device unencrypted (as plain text) leaves both them and any encrypted data vulnerable to precisely the same type of attack that the encryption was designed to avoid.

This apparent paradox can be solved by means of a transient key which is not permanently stored on the device itself.

One common implementation of a transient key protocol is provided in the popular PGP (Pretty Good Privacy) software originally designed by Phil Zimmermann. Keys are stored in an encrypted private store called a keyring, which is protected by a passphrase that the user has to remember. This passphrase is never stored on the device itself; when entered by the user, it enables the derivation of a transient protection key, which is never kept in persistent storage but only in volatile memory. This transient key is used to symmetrically encrypt and decrypt the keyring.

According to http://en.wikipedia.org/wiki/Authentication:
“The methods by which a human can authenticate themselves are generally classified into three cases:
   Something the user is (e.g., fingerprint or retinal pattern, DNA sequence (there are assorted definitions of what is sufficient), voice pattern (again several definitions), signature recognition or other biometric identifier)
   Something the user has (e.g., ID card, security token, software token or cell phone)
   Something the user knows (e.g., a password, a pass phrase or a personal identification number (PIN))
Sometimes a combination of methods is used, e.g., a bank card and a PIN, in which case the term ‘two-factor authentication’ is used.”

Methods based on authenticating who a user is have historically been computationally expensive in terms of both time and equipment where the personal data used is biometrically ‘hard’ (such as fingerprint or retinal scan or DNA) or else subject to change over time and susceptible to forgery where the data used is ‘soft’ (such as photographs and signatures, which are gradually being phased out as authentication factors on items such as passports and credit cards).

Methods based on authenticating something a user has are inherently limited to a small number of items and are also susceptible to theft and loss; people find it practicably impossible to carry dozens of different items with them and to rely on one common item introduces a highly susceptible single point of failure or attack. Additionally, both these methods are difficult to use in the remote authentication situations which are commonly used by computing devices in internet and telephone communication.

Consequently, the prior art as outlined above tends to be limited to authentication based on something that the user knows. Knowledge is quick and inexpensive to verify, it can be used remotely, and cannot easily be physically lost or stolen.

However, this type of authentication method can only be used reliably if the knowledge can be guaranteed to have been kept secret. When this essential secrecy has been compromised, the authentication is worthless. There are now many methods in use by malware and criminal gangs that make use of security vulnerabilities in systems that rely on secret knowledge. Among the most notorious of these are:
internet ‘phishing’ attacks, which seek to trick users into divulging secret passwords
spyware which infects computing devices and records keystrokes used in authentication
false front and ‘lebanese loop’ attacks on cashpoints machines by which criminals trick users into divulging their PINS while simultaneously leaving their access cards in ATMs.

As well as these inadvertent disclosures of secret information, there are increasing instances and opportunities for deliberate leakage of secret access information, where the authorised user of a resource colludes in its misappropriation by a third party. Divulging access codes which enable piracy of computer software packages and digitally protected media content is an example of this type of leakage.

But at the same time as knowledge-based authentication has come under increasing attack, advances in technology have begun to bring down the expense involved in authentication based on something the user is. Biometric verifications of identity are now practical propositions on many devices; for example, a mobile phone with fingerprint recognition, the Pantech GI100, was launched in 2004 (see http://www.mobilemag.com/content/100/340/C3462/).

It is now increasingly practical in many situations to employ multi-factor authentications schemes, which overcome the limitations of individual authentication properties by using them in combination.

Ideally, the choice of which authentication method or methods to use in any circumstance should be a tradeoff based on the perceived damage arising from a security breach in any particular case, the perceived costs of the authentication, and the perceived threats. For example, if a person is eating lunch at an establishment where they are well-known, it would be considered disproportionate, unnecessary and excessively expensive for the manager to insist on the taking of fingerprints and retinal scans for a full biometric verification of identity when paying for relatively inexpensive food and drink with a bank debit card. However, such precautions may not be considered to be out of place if the person took the same bank debit card to a branch of the person's bank, and requested the entire balance of the account to be paid out in cash.

Additionally, the appropriate choices for any circumstance cannot be regarded as fixed. As social trends and the available technology change, the limits of acceptability and practicality are liable to change also. Circumstances also alter security calculations, both socially and personally; for example, the perception of a high danger of terrorist attacks may make it possible to enforce stronger and costlier methods of authentication for passengers on transport networks.

According to a first aspect of the present invention there is provided a method of operating a computing device comprising using one or a combination of methods chosen from amongst a plurality of methods for authenticating a user of the device by means of:
a. providing the said user of the device with a unique CPK which can be used to guard or encrypt sensitive data and functionality; and
b. providing for each authentication method a means of returning a unique CIS each time it is employed by the said user; and
c. for each authentication method available to the device
   i. passing the said CIS through replicable mathematical mechanisms which generate a CISK unique to that CIS but from which the CIS cannot be derived; and
   ii. employing the said CISK to symmetrically encrypt the CPK; and
   iii. keeping the said encrypted version of the CPK in some type of persistent storage available to the device in such a way that is can be retrieved by providing the authentication method and the user;
and wherein, when a user of the device requests authentication by means of one or a combination of available authentication methods
a. for each authentication method required
   i. that method is invoked to obtain its CIS for the said user; and
   ii. the said CIS is passed through the mathematical mechanisms described above to generate a CISK; and
   iii. the encrypted CPK for the said method and the said user is retrieved from the persistent storage where it is kept; and]
   iv. the actual CPK is decrypted from the encrypted CPK means of the CISK; and
b. authentication is provided by releasing the identify of the user and their CPK provided that either
   i. the CPKs returned by each authentication method required are identical; or
   ii. in the case where only a single authentication method is required, that it can successfully be used to decrypt a specific item of data stored on the device.

According to a second aspect of the present invention there is provided a computing device arranged to operate in accordance with a method of the first aspect.

According to a third aspect of the present invention there is provided an operating system for causing a computing device to operate in accordance with a method of the first aspect.

Embodiments of the present invention will now be described, by way of further example only, with reference to the accompanying drawings, wherein:—

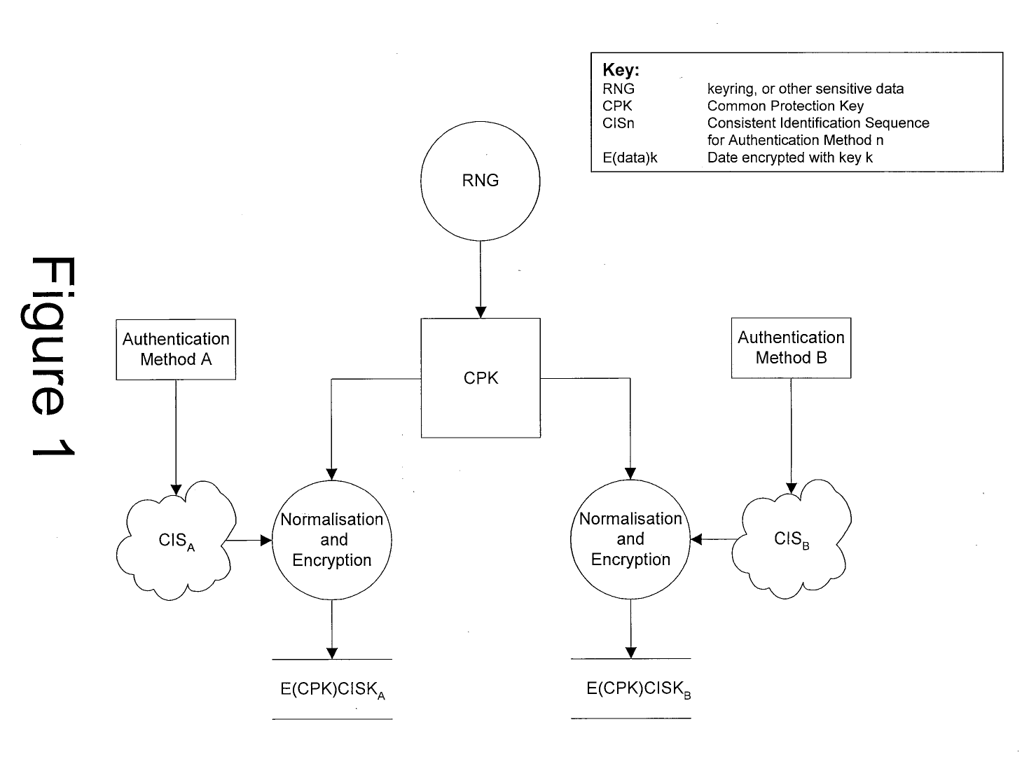

FIG. 1 shows an authentication method according to the present invention;

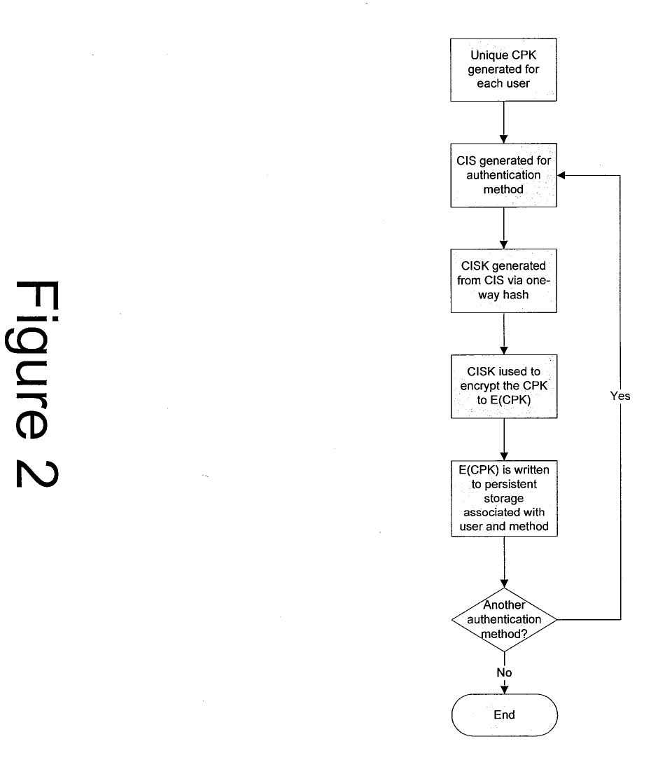

FIG. 2 shows a registration process for a method of the present invention; and

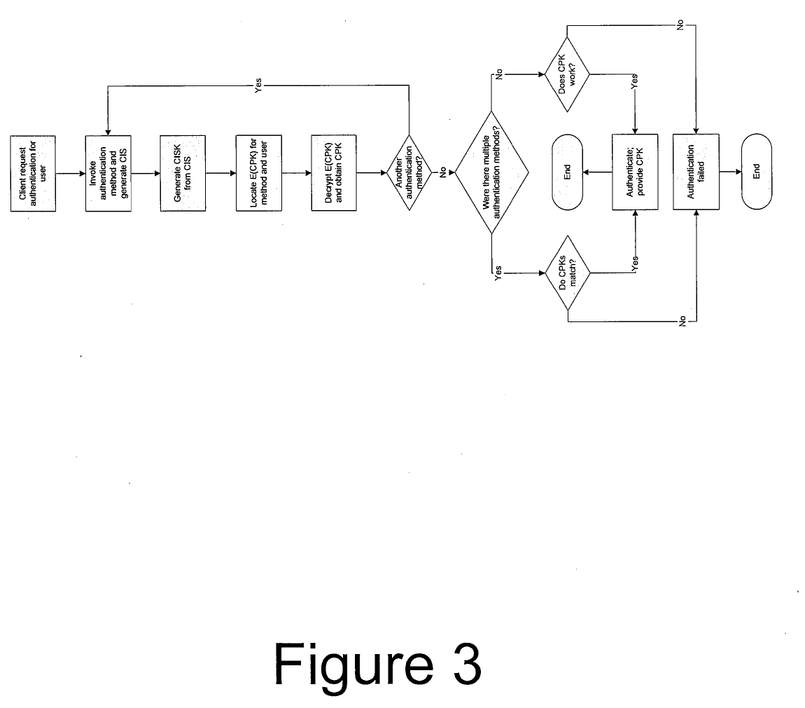

FIG. 3 shows an embodiment of the present invention.

A perception behind this invention is that there is a need to be able to choose dynamically the most appropriate authentication method or methods from a number of possible authentication methods, depending on the circumstances under which authentication is requested and the methods that are practical at any point in time.

Furthermore, to protect against plaintext attacks on the filesystem of a device, the invention also enables the type of transient key protection described above to be independently available to each of the authentication methods.

While modern computing devices, especially those with communications capabilities such as smart phones, are increasingly able to make use of a wide range of authentication methods, any single one or combination of which may be used or required at any time, the known devices do not allow for how this type of dynamic selection of one from amongst a number of methods employing transient key protection might be made. The existing devices, and the methods which they employ, incorporate fixed authentication techniques and cannot readily be adapted to dynamically change from one method to another.

Furthermore, the present invention also envisages allowing the addition of extra authentication methods as technology develops and the calculus of risks and costs alters. Adding authentication methods on a device implies it must be capable of storing multiple additional sets of data relating to their use; and each one of these needs to be stored in such a way that they are not vulnerable to plain text attack but are nevertheless available for use in the verification process prior to any authentication taking place.

This invention discloses, therefore, a means by which a computing device is able to safely store multiple encrypted keys for multiple possible authentication methods, which can be chosen dynamically on demand, and which allows for the dynamic addition of extra methods.

Furthermore, this invention can easily be adapted to be used by existing applications that currently make use of fixed authentication methods (such as PGP). It provides such applications, and computing devices which implement it, with:
the ability to use a dynamic number of available authentication methods which may increase or decrease over time—additional methods can be added or removed in response to changes in their practicality, reliability, availability and acceptability;
the ability to dynamically choose which methods are used to authenticate any particular operation—this may mean one method, one of many methods, or a combination of a few or several methods, with the decision being influenced by either the calling application or even the user if they are given an opportunity to express a preference.

A feature of this invention is the employment of an entity on the computing device that acts as a local Authentication Server (AS), which enables any of the various authentication methods to return a Consistent Identification Sequence (CIS) for any given user. If, for example, a fingerprint method returns a sequence of data octets after analysing a fingerprint, then the local authentication server guarantees that the sequence returned will be the same each time the same user authenticates with the same finger.

It is stressed that the requirement for consistency does not mean results obtained from an authentication method cannot be variable. However, before a method that produces variable results can be used for authentication, a period of training will generally be needed in order to ensure that it can reliably return a CIS. The training process preferably establishes the typical parameters which enable the method to be considered as reliable. In the case of the fingerprint method described above, the absence of unexplained points of dissimilarity together with a certain number of points of similarity would trigger the return of the same CIS irrespective of what those points of similarity might be. Equally, the use of a voiceprint would preferably need to be flexible enough to identify the voice of a specific individual consistently and reliably under a variety of circumstances. The precise nature of these training processes will vary from one authentication method to another, and are considered to be outside the scope of this invention.

Given the availability of an AS that returns a consistent CIS for each authentication method, a proposed scheme according to the present invention might work as follows for each user who registers to use the computing device:
1. A Common Protection Key (CPK) is generated for each user at the time they register. This key is sourced from a random number generator, and is only ever stored transiently in Random Access Memory (RAM). It is important to note that the CPK is never kept in any form of persistent storage.
2. As described above, each authentication method will return a different Consistent Identification Sequence which is then successively passed through
   (a) a one-way hash or other mathematical function which generates a number unique to the CIS but from which the CIS cannot be derived; and then through
   (b) a key generation function to yield a CIS Key (CISK).
3. The CISK is then used to encrypt the CPK, the results of which can be safely written to the file system.
4. Steps 2 and 3 are then repeated for each authentication method the user requires; there is therefore a separately encrypted version of the same CPK for each available authentication method.

FIG. 1 illustrates this process with two authentication mechanisms, either of which can grant access, in this case to an encrypted keyring (RNG). Note that in this embodiment the process of translating a CIS into a CISK is implicitly performed by the encryption function.

FIG. 2 shows the registration processes sequentially as a flowchart.

The result of such processing can be stored on the computing device in tabular form, as shown below. In this table, there are three notional users (User0, User1 and User2) and three possible authentication methods (ModeA, ModeB and ModeC). For each combination of user and authentication method, the table holds the CPK as encrypted by the CISK, as shown in the following table.

| | | Authentication Method | | |
|---|---|---|---|---|
| | | ModeA | ModeB | ModeC |
| User | User0 | E(CPK₀)CISK_{A0} | E(CPK₀)CISK_{B0} | E(CPK₀)CISK_{C0} |
| | User1 | E(CPK₁)CISK_{A1} | E(CPK₁)CISK_{B1} | E(CPK₁)CISK_{C1} |
| | User2 | E(CPK₂)CISK_{A2} | E(CPK₂)CISK_{B2} | E(CPK₂)CISK_{C2} |

Key
CPKn Protection Key for User n
CPKmn Transient Key from Mode n for User n
E(Data)k Data Encrypted with Key k

Note that the structure of a table such as this is by no means fixed; for example, columns corresponding to new authentication methods and rows corresponding to new users can be added as required.

The table is used as follows:
1. A client application requests authentication for some reason. This request may contain criteria which specifies an AND or OR combination of the available methods e.g. (fingerprint AND PIN) or (fingerprint OR voiceprint).
2. The authentication infrastructure invokes the relevant authentication methods for the user of the device. Each method used returns a CIS which is processed into its CISK form.
3. For each method, the CISK can be used to decrypt the CPK from the entry in the table which corresponds to the user and authentication mode in use, E(CPKₙ)CISKₘₙ.
4. When multiple authentication methods are used, the CPKs decrypted from each entry in the table for each method should be identical; if not, the authentication has failed. The authentication infrastructure will check this for any AND criteria specified by the client.
5. Where only a single authentication method is in use, the validity of the CPK it gives can only be determined by attempting to use it; typically, the authentication infrastructure will maintain a small data item which includes an internal consistency check for this purpose.
6. Once the authentication infrastructure has confirmed the validity of the CPK, it releases the identity of the user, and the user's CPK to the client.
7. The client can then employ the CPK to encrypt or decrypt information pertinent to that user.

FIG. 3 shows these processes sequentially as a flowchart.

Note that at no time is it necessary to store the CPK or the CISK other than transiently in RAM; avoiding persistent storage of these items is a requirement on each client.

As an optimisation of the above procedure, a one-way hash of each CISK can be generated during the registration process, and stored in the table as a tuple together with the CPK as encrypted by that CISK. When this optimisation is implemented, the resulting table (shown below) is used in broadly the same way as the first table shown above, except that each CISK returned by each authentication mechanism is subjected to the same hash, and matched with the hashed CISK stored in the table. This check avoids the need to decrypt something to check that the CISK is valid.

Such a table with the optimised method may look as follows:

| | | Authentication Method | | | | | |
|---|---|---|---|---|---|---|---|
| | | Id-A | ModeA | Id-B | ModeB | Id-C | ModeC |
| User | User0 | H(CISKA₀) | E(CPK₀)CISK_{A0} | H(CISKB₀) | E(CPK₀)CISK_{B0} | H(CISKC₀) | E(CPK₀)CISK_{C0} |
| | User1 | H(CISKA₁) | E(CPK₁)CISK_{A1} | H(CISKB₁) | E(CPK₁)CISK_{B1} | H(CISKC₁) | E(CPK₁)CISK_{C1} |
| | User2 | H(CISKA₂) | E(CPK₂)CISK_{A2} | H(CISKB₂) | E(CPK₂)CISK_{B2} | H(CISKC₂) | E(CPK₂)CISK_{C2} |

| | |
|---|---|
| Key | |
| CPKn | Protection Key for User n |
| CPKmn | Transient Key from Mode n for User n |
| H(data) | The Hash of some data |
| E(Data)ₖ | Data Encrypted with Key k |

Enhancements to the above processes may be implemented for untrusted clients.

It is conceivable that a malicious client may obtain the CPK and then publish it, thus leaving protected data open to attacks which only need to defeat the file system protection on the device.

In environments where some unique and unspoofable identifier is available for clients, it is possible to take an additional step and generate a further key by processing both the CPK and this identifier; for example, by generating a password by an XOR of their hashes, which can be written formulaically as PKCS#5(H(CPK)̂H (ClientIdentifier)). The result is again a Common Protection Key unique to the client in question rather than shared between trusted clients. Deliberately publishing this key is of little or no benefit since nobody else is using it. The limitation here is that only this specific client can decrypt data it encrypted. No protected data can be shared between clients without the clients making explicit provision for export and import.

To add authentication methods is relatively straightforward. Since the invention stores all data in a standard table, it can be manipulated by conventional database functions and procedures. Adding extra columns is therefore a straightforward operation to those skilled in the art.

As well as the three basic methods of authentication listed above (based on who you are, what you have, and what you know) this process is straightforward to use with other methods, including but not restricted to methods analogous to the following:
location-based authentication, such as only allowing a particular atm, charge, or credit card to be used at a specific merchant or at a specific bank branch, or only allowing root access from specific terminals
time-based authentication, such as only allowing access from certain accounts during normal working hours
size-based authorization, such as only allowing a specific transaction to be for a specific exact amount
pre-authorized transactions, such as where a company uploads all of the check numbers and amounts written for each check to their bank, and the bank would then reject any check not of those numbers and amounts as fraudulent.
(from http://en.wikipedia.org/wiki/Authentication)

Combining these methods with others leads to some innovative permutations not possible without this invention; for example, a computing device equipped for electronic commerce and banking could dynamically impose a far more stringent set of authorization methods for high-value transactions than for low-value ones; or a different set of authorization methods could be applied for a location-aware device when it is used in an unfamiliar location, to ensure that it had not been stolen.

The present invention can be used with existing applications. One of the most widely used applications, as mentioned earlier, is PGP. With this invention, any authentication method or combination of methods could be used instead of the current sole method of passphrase entry to unlock the private key rings. By returning a single value to PGP regardless of the authentication mechanism employed, the application need have no knowledge of the actual mechanisms used.

Similarly, clients of such an authentication service benefit by not simply just determining the identity of the current user; they are also provided with a per-user CPK which can be immediately used to encrypt/decrypt information specifically for that user.

This invention removes the need for any client to manage and protect any of its own per-user keys while continuing to keep the critical information transient at all times. Essentially it relieves the clients of any key management issues when protecting information specific to a given user, whether privacy or security related.
For example, a user's client-side banking certificate key can now be itself protected using one or more biometric authentication methods supported on the device.
Applications can, independently of any particular method, authenticate the user and make use of whatever encryption and decryption methods are necessary to protect and access the user's data (such as a personal address book).

It can be realized from the above description that many advantages can accrue through the use of the present invention. This invention is applicable to any device with controlling software that needs to support multiple authentication methods. It enables:
dynamic selecting of different methods of authentication
dynamic selection of different combinations of methods of authentication
addition or removal of additional methods of authentication on demand
support for multiple users with different methods of authentication and different private data
safe permanent storage of encrypted private keys
no permanent storage of any unencrypted keys
backward compatibility with existing applications

Although the present invention has been described with reference to particular embodiments, it will be appreciated that modifications may be effected whilst remaining within the scope of the present invention as defined by the appended claims.

1. A method of operating a computing device comprising using one or a combination of methods chosen from amongst a plurality of methods for authenticating a user of the device by means of:
a. providing the said user of the device with a unique CPK which can be used to guard or encrypt sensitive data and functionality; and
b. providing for each authentication method a means of returning a unique CIS each time it is employed by the said user; and
c. for each authentication method available to the device
i) passing the said CIS through replicable mathematical mechanisms which generate a CISK unique to that CIS but from which the CIS cannot be derived; and
ii) employing the said CISK to symmetrically encrypt the CPK; and
iii) keeping the said encrypted version of the CPK in some type of persistent storage available to the device in such a way that is can be retrieved by providing the authentication method and the user;
and wherein, when a user of the device requests authentication by means of one or a combination of available authentication methods
d. for each authentication method required
i) that method is invoked to obtain its CIS for the said user; and
ii) the said CIS is passed through the mathematical mechanisms described above to generate a CISK; and
iii) the encrypted CPK for the said method and the said user is retrieved from the persistent storage where it is kept; and
iv) the actual CPK is decrypted from the encrypted CPK means of the CISK; and
e. authentication is provided by releasing the identify of the user and their CPK provided that either
i) the CPKs returned by each authentication method required are identical; or
ii) in the case where only a single authentication method is required, that it can successfully be used to decrypt a specific item of data stored on the device.

2. A method according to claim 1 wherein authentication is requested by a client and is provided by an authentication server component.

3. A method according to claim 1 wherein CPK and CIS and CISK data is only held transiently in the memory of the device and is never stored persistently.

4. A method according to claim 1 wherein the CPK is rendered unique by deriving it from a random number generator.

5. A method according to claim 1 wherein the device supports authentication for multiple users each of which has their own unique CPK.

6. A method according to claim 1 wherein combinations of authentication methods can be dynamically chosen by the user or operating or application software of the device.

7. A method according to claim 1 wherein the choice of authentication methods is varied depending on the location of the device.

8. A method according to claim 1 wherein the choice of authentication methods is automatically varied depending on the location of the device.

9. A method according to claim 1 wherein authentication is requested pursuant to a financial transaction and wherein the choice of authentication methods is automatically varied depending on the size of the transaction.

10. A method according to claim 1 wherein the encrypted version of the CPK is kept in persistent storage in tabular form where the rows and columns represent the corresponding authentication method and user.

11. A method according to claim 1 wherein either authentication methods or users or both can be dynamically added or removed.

12. A method according to claim 1 wherein the mathematical mechanisms used to generate the CISK can be replaced.

13. A method according to claim 1 wherein authentication methods are trained for each user to enable them to return a CIS.

14. A method according to claim 1 wherein a one-way hash is generated each time a CISK is generated, and wherein each persistently stored CISK, stored as a tuple together with the said hash, and wherein authentication is dependent on the hashes of the CISKs generated by each authentication method and user matching a hashes stored for that authentication method and user.

15. A method according to claim 1 by which the CPK is further mathematically modified by means of the unique identifier relating to a specific client.

16. A computing device arranged to operate in accordance with a method as claimed in claim 1.

17. An operating system for causing a computing device to operate in accordance with a method as claimed in claim 1.
